(19) United States
(12) Patent Application Publication
(10) Pub. No.: US 2019/0146724 A1
(43) Pub. Date: May 16, 2019

(54) IMAGE FORMING APPARATUS, INFORMATION PROCESSING APPARATUS, CONTROL METHOD OF IMAGE FORMING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: Jun Itoh, Kashiwa-shi (JP)

(21) Appl. No.: 16/183,958

(22) Filed: Nov. 8, 2018

(30) Foreign Application Priority Data
Nov. 14, 2017 (JP) 2017-219381

(51) Int. Cl. G06F 3/12

(52) U.S. Cl. CPC G06F 3/1204; G06F 3/1297; G06F 3/1257

(57) ABSTRACT

It is made possible to generate printed matter intended by a user without the user individually performing print setting for a master set and for a copy set. The image forming apparatus of the present invention includes: at least one processor that executes a set of instructions to: acquire a print setting registered in advance, which is applied to printing of a specific kind of set, or a print setting registered in advance, which is applied to printing on a sheet of a specific sheet feed cassette; and apply the acquired print setting registered in advance in a case of performing printing of a plurality of sets including a set that is printed by using a sheet of a first sheet feed cassette and a set that is printed by using a sheet of a second sheet feed cassette based on specific print data for printing the plurality of sets.

### BACKGROUND OF THE INVENTION

### Field of the Invention

The present invention relates to an image forming apparatus that performs printing by switching sheet feed cassettes for each set.

### Description of the Related Art

Conventionally, a function called carbon copy that switches sheet feed cassettes for each set in a case where a plurality of sets of printed matter is printed is known (see Japanese Patent Laid-Open No. 2011-188294). In the carbon copy function, for example, it is possible to specify the sheet feed cassette that supplies a sheet used for a master set and the sheet feed cassette that supplies a sheet used for a copy set in a print job. An image forming apparatus having received the print job performs printing by switching the sheet feed cassettes at the time of change from printing of a set to printing of the other set. In this manner, it is possible to generate a plurality of sets of printed matter having the same contents by using different sheet feed cassettes. For example, it is possible to implement an aspect in which a master set is printed on a high quality sheet and a copy set is printed on a backing sheet throughout one print job.

However, in a case where a user performs the printing as described above, it is necessary to perform setting of whether or not to perform combination printing of “confidential” or the like for a copy set after performing setting of printing each set as a master set or a copy set for a printer driver. Further, in order to generate desired printed matter, it is necessary for a user to appropriately perform setting for each set, and therefore, effort and time of a user occur.

### SUMMARY OF THE INVENTION

The image forming apparatus according to the present invention is an image forming apparatus capable of processing specific print data for printing a plurality of sets including a set that is printed by using a sheet of a first sheet feed cassette and a set that is printed by using a sheet of a second sheet feed cassette, the image forming apparatus including: a memory device that stores a set of instructions; and at least one processor that executes the set of instructions to: acquire a print setting registered in advance, which is applied to printing of a specific kind of set, or a print setting registered in advance, which is applied to printing on a sheet of a specific sheet feed cassette; and apply the acquired print setting registered in advance in a case of performing printing of a plurality of sets including a set that is printed by using a sheet of a first sheet feed cassette and a set that is printed by using a sheet of a second sheet feed cassette based on specific print data for printing the plurality of sets.

Further features of the present invention will become apparent from the following description of exemplary embodiments with reference to the attached drawings.

### BRIEF DESCRIPTION OF THE DRAWINGS

FIG. 1A and FIG. 1B are diagrams for explaining an MFP;

FIG. 2A and FIG. 2B are diagrams for explaining a configuration of a PC;

FIG. 3A and FIG. 3B are diagrams each showing a UI screen example of a printer driver;

FIG. 4 is a conceptual diagram for explaining a configuration of PDL data;

FIG. 5 is a conceptual diagram of PDL data in a case where sheet feed cassettes are switched for each set;

FIG. 6 is a diagram showing a specific example of PDL data;

FIG. 7 is a sequence diagram showing processing from activation of a printer driver by a user until printing in the MFP is completed;

FIG. 8 is a flowchart showing general printing processing;

FIG. 9A and FIG. 9B are diagrams for explaining general printing processing;

FIG. 10A and FIG. 10B are diagrams each showing an example of a UI screen for performing print setting for each kind of purpose;

FIG. 11 is a flowchart showing an example of printing processing to switch print settings for each kind of purpose;

FIG. 12A and FIG. 12B are diagrams each showing an example of a UI screen for performing print setting for each sheet feed cassette; and

FIG. 13 is a flowchart showing an example of printing processing to switch print settings for each of kind of purpose.

### DESCRIPTION OF THE EMBODIMENTS

In the following, embodiments for embodying the present invention are explained by using the drawings. The following embodiments are not intended to limit the present invention according to the scope of the claims and all combinations of features explained in the present embodiments are not necessarily indispensable to the solution of the present invention.

### First Embodiment

<Explanation of MFP (Multi Function Peripheral)>

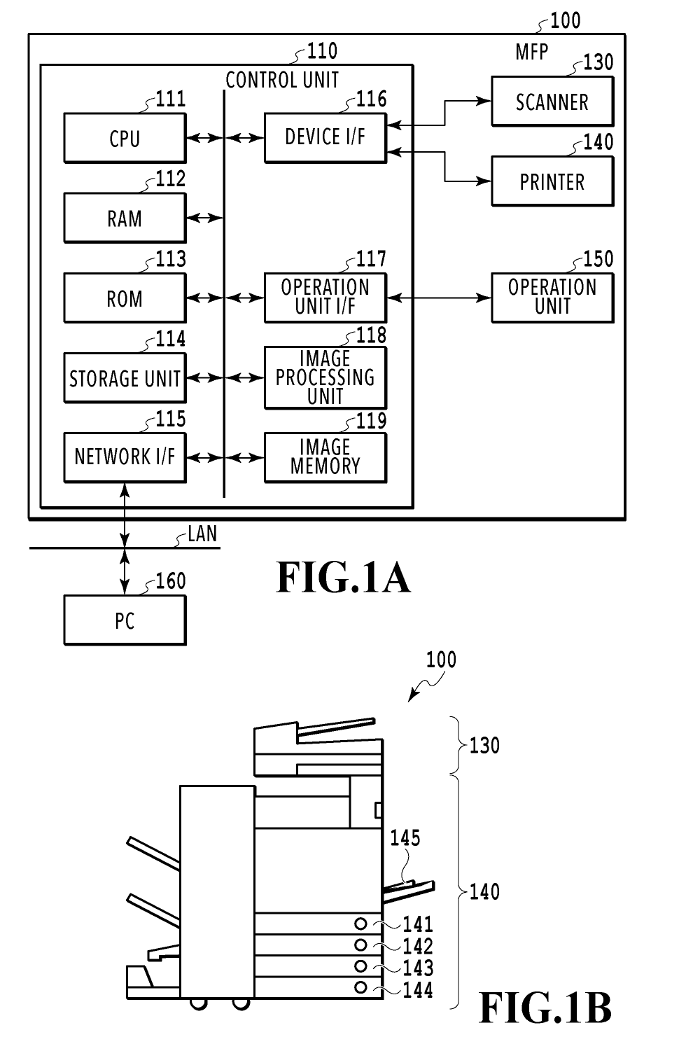

FIG. 1A and FIG. 1B are diagrams for explaining an MFP 100 used as an image forming apparatus in a first embodiment. FIG. 1A is a block diagram showing a configuration of a printing system including the MFP 100. The MPF 100 is capable of processing specific print data for performing printing of a plurality of sets including a set that is printed by using a sheet of a first sheet feed cassette and a set that is printed by using a sheet of a second sheet feed cassette. The MFP 100 includes a control unit 110, a scanner 130, a printer 140, and an operation unit 150. The control unit 110 includes a CPU 111, a RAM 112, and a ROM 113. Further, the control unit 110 includes a storage unit 114, a network I/F (InterFace) 115, a device I/F 116, an operation unit I/F 117, an image processing unit 118, and an image memory 119.

The control unit 110 is connected with the scanner 130, which is an image input device, and the printer 140, which is an image output device, and controls input and output of image information. Further, the control unit 110 is connected to a LAN (Local Area Network) and performs reception of a print job including PDL (Page Description Language) data via the LAN, and the like.

The CPU 111 controls the operation of the MFP 100 and operates based on programs stored in the RAM 112. The ROM 113 is a boot ROM and in which a boot program of the system is stored. The storage unit 114 stores system software, image data, programs for controlling the operation of the MFP 100, and so on. The program stored in the storage unit 114 is loaded onto the RAM 112. The CPU 111 controls the operation of the MFP 100 based on the program loaded onto the RAM 112. The network I/F 115 is connected to a LAN, performs communication with an external device, such as a PC (Personal Computer) 160, via a network, and governs input and output of various kinds of information. The device I/F 116 connects the scanner 130 and the printer 140 with the control unit 110 and performs synchronous/asynchronous system conversion of image data. The operation unit I/F 117 is an interface that connects the operation unit 150 and the control unit 110 and outputs image data that the operation unit 150 is caused to display to the operation unit 150. Further, the operation unit I/F 117 transmits information a user inputs to the operation unit 150 to the CPU 111. The operation unit 150 is a user interface unit having an input/output unit configured to input and output various kinds of information. The operation unit 150 has a user interface unit into which the display unit and the input/output unit are integrated and displays image data input from the operation unit I/F 117 on the display unit. The image processing unit 118 performs image processing for print data received via a LAN, performs image processing for image data that is input/output from the device I/F device 116, and so on. The image memory 119 is a memory for temporarily loading image data that is processed by the image processing unit 118.

FIG. 1B is a diagram showing the external appearance of the MFP 100. In the MFP 100, the scanner 130 is arranged on the top of the printer 140. The printer 140 is provided with two kinds of sheet holding units, that is, a plurality of cassettes 141 to 144 capable of holding hundreds of sheets in one cassette and a manual feed tray 145 capable of easily exchanging sheets. The size and type of the sheet that is loaded on the cassettes 141 to 144 and the manual feed tray 145 are set by a user specifying them via an operation screen, not shown schematically, and the size and type are stored in the ROM 113 in association with each cassette and the manual feed tray. It may also be possible to automatically detect the sheet size and type of the information relating to the sheet by various sensors and to make it possible to set the detection results.

### <Explanation of PC>

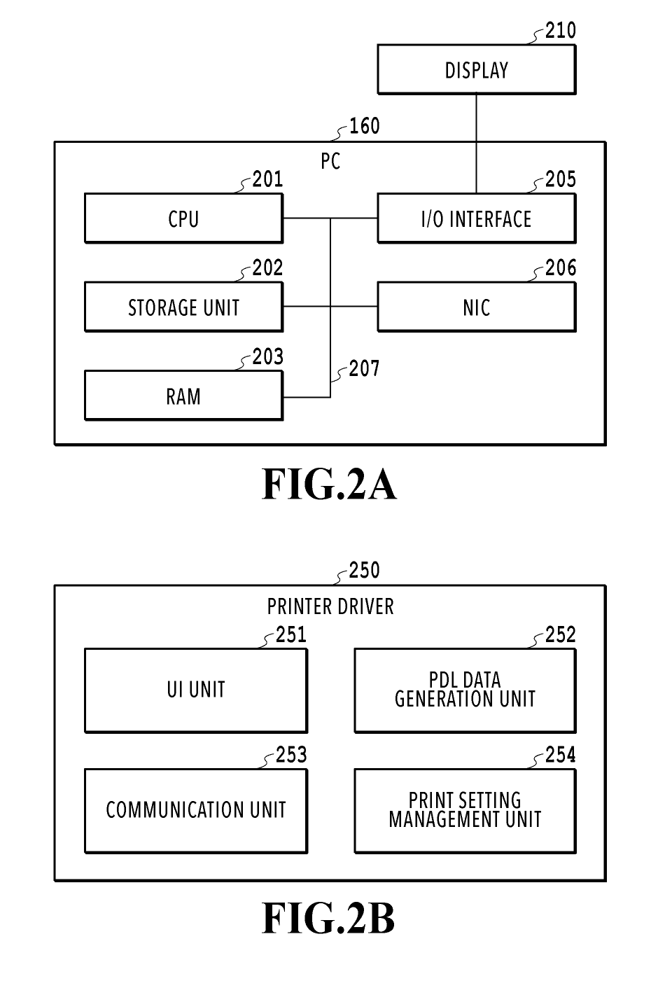

FIG. 2A is a diagram showing a hardware configuration of the PC 160. The PC 160 includes a CPU 201, a storage unit 202, a RAM 203, an I/O (Input/Output) interface 205, and a MC (Network Interface Card) 206. The CPU 201 is a unit configured to implement a variety of functions by executing various programs. The storage unit 202 is a unit configured to store various programs, setting data and so on. The CPU 201 loads a program stored in the storage unit 202 onto the RAM 203 and executes the program. The RAM 203 is also made use of as a temporary work storage area of the CPU 201. The I/O interface 205 is an interface unit configured to receive data from a pointing device (not shown schematically), as well as transmitting data to a display 210 connected to various devices and the PC 160. The NIC 206 is a unit configured to connect the PC 160 to a network. The units explained above are capable of performing transmission and reception of data via a bus 207.

FIG. 2B is a diagram showing a configuration of a software that operates on the PC 160. Specifically, FIG. 2B is a diagram showing a configuration of a printer driver 250 that performs print control of the MFP 100. A software program that implements the printer driver 250 is stored in the storage unit 202. The printer driver 250 has a function to communicate with the MFP 100 in response to a request from an application and transmit a print job including PDL data generated on the PC 160 to the MFP 100.

The printer driver 250 includes a UI (User Interface) unit 251, a PDL data generation unit 252, a communication unit 253, and a print setting management unit 254. The UI unit 251 provides a user interface relating to the print setting of the printer driver 250. The PDL data generation unit 252 generates PDL data in accordance with the specified print setting. The communication unit 253 performs network communication with the MFP 100 by using the NIC 206. The print setting management unit 254 presents a print setting screen to a user via the UI unit 251 and manages print setting information relating to printing execution. The print setting information is stored in the storage unit 202.

### <UI Screen at the Time of Print Setting of Printer Driver>

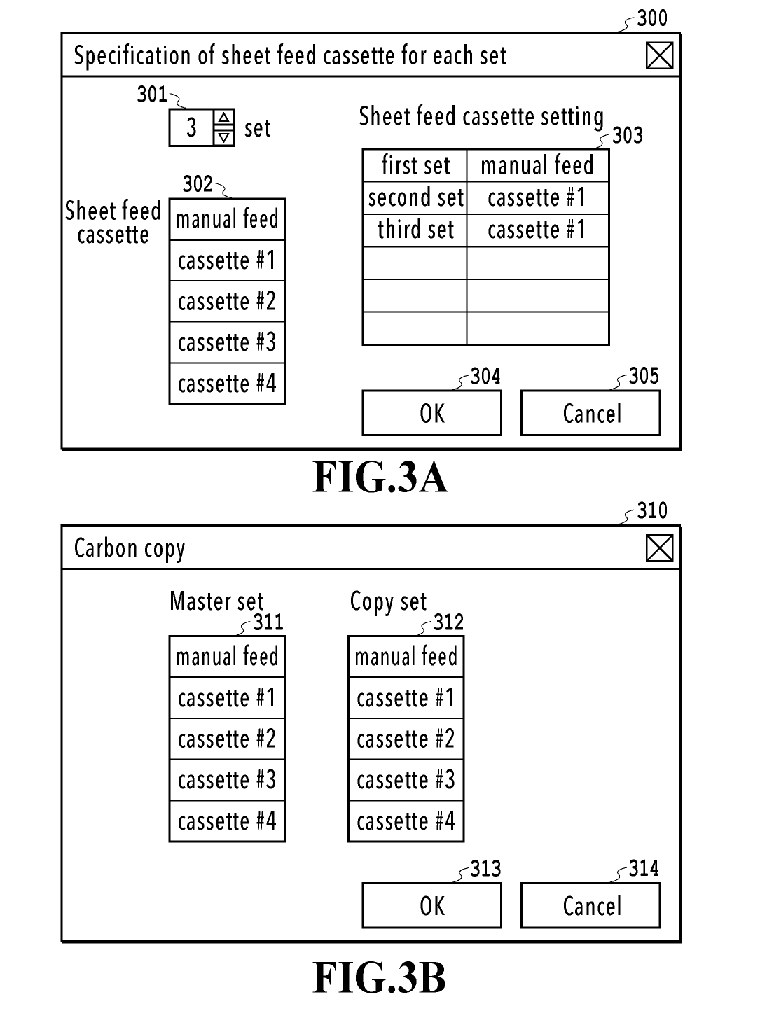

In this embodiment, the printer driver 250 has a function to instruct a printing apparatus to output a plurality of print products including a master set and a copy set, based on the same print data. For example, the printer driver 250 instructs the MFP 100 to output, as the master set for a customer, a coated paper on which the print data is printed, and, as the copy set for a private duplicate, a recycled paper on which the same print data is printed. FIG. 3A and FIG. 3B are diagrams each showing a UI screen example of the print driver 250 that performs setting for switching sheet feed cassettes to feed a sheet (may also be called sheet feed units, sheet feed trays, or sheet supply sources) for each set. In FIG. 3A, a UI screen example in a case where the number of sets is set and the sheet feed cassette is selected for each set is shown. In FIG. 3B, a UI screen example in a case where a master set and a copy set are distinguished from each other and the sheet feed cassettes are switched between the master set and the copy set. In the present embodiment, the sheet feed cassette for each set may be set in one of the aspects in FIG. 3A and FIG. 3B. In the following, a cluster of print-target documents to be printed is called a “set”. Further, in a case where each set is specified specifically, each set is described as the first set, the second set, . . . , and the Xth set (X is a natural number).

A UI screen 300 shown in FIG. 3A includes a set selection field 301, a sheet feed cassette selection field 302, a sheet feed cassette setting list 303, an OK button 304, and a Cancel button 305. In a case where switching of sheet feed cassettes for each set is specified through a UI screen, not shown schematically, the UI screen 300 is displayed. It is possible for a user to perform setting to switch sheet feed cassettes through the UI screen 300. The set selection field 301 is a field to select a set for which a sheet feed cassette is desired to be selected. On the UI screen 300, an example of a case where setting of the third set is performed is shown. In the selection field 302, the sheet feed cassettes included in the MFP 100 that performs printing processing are shown in a list. It is possible for a user to select a desired sheet feed cassette through the UI screen 300. More specifically, a user selects a sheet feed cassette from which a sheet is fed in the selection field 302 for the Xth set selected in the set selection field 301. The setting list 303 is an area in which the setting of the sheet feed cassette for each set, which is set through the set selection field 301 and the selection field 302, is displayed in a list format. In a case where the OK button 304 is pressed down in the state where the sheet feed cassette corresponding to each set is set in the setting list 303, the printer driver 250 saves the setting information. On the other hand, in a case where the Cancel button 305 is pressed down, the printer driver 250 discards the setting information. In a case where the number of sheet feed cassettes set through the UI screen 300 is smaller than the number of printing sets specified through a UI screen, not shown schematically, it may also be possible to set the sheet feed cassette set last in the list as the sheet feed cassette of the remaining set(s).

A UI screen 310 shown in FIG. 3B includes a sheet feed cassette selection field 311 of for a master set, a sheet feed cassette selection field 312 of for a copy set, an OK button 313, and a Cancel button 314. The sheet feed cassette selection field 311 for a master set is a field to select a sheet feed cassette used for a master set. The sheet feed cassette selection field 312 for a copy set is a field to select a sheet feed cassette used for a copy set. It is not possible to select the sheet feed cassette selected in the sheet feed cassette selection field 311 for a master set in the sheet feed cassette selection field 312 for a copy set. Further, it may also be possible to select a plurality of sheet feed cassettes in the sheet feed cassette selection field 312 for a copy set. In a case where the OK button 313 is pressed down in the state where the sheet feed cassette for a master set and the sheet feed cassette for a copy set are selected, the printer driver 250 saves the setting information. On the other hand, in a case where the Cancel button 314 is pressed down, the printer driver 250 discards the setting information.

### <Explanation of PDL Data>

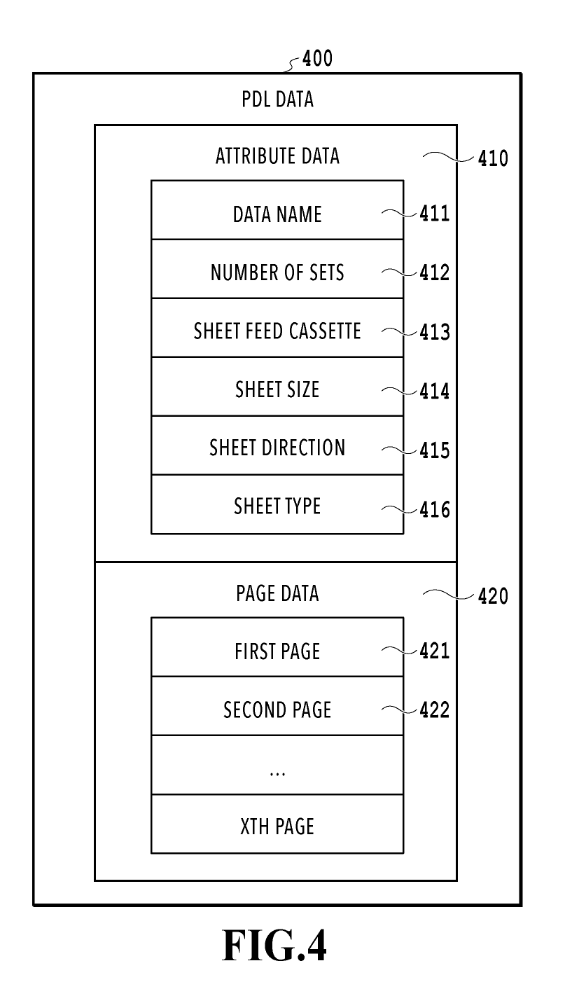

FIG. 4 is a conceptual diagram for explaining a configuration of PDL data 400. The PDL data 400 is generated by the printer driver 250 as a print job and transmitted to the MFP 100. The information on the sheet feed cassette for each set explained in FIG. 3A and FIG. 3B is included in the PDL data 400 and transmitted to the MFP 100. As shown in FIG. 4A, the PDL data 400 includes attribute data 410 and page data 420. The attribute data 410 includes each piece of information, that is, data name 411, number of sets 412, sheet feed cassette information 413, sheet size 414, sheet direction 415, and sheet type 416. The data name 411 is a name for identifying the PDL data 400 and is information given based on the file name and the like of application data that is the source of the PDL data 400. The number of sets 412 is information indicating the number of printing sets. The sheet feed cassette information 413 is information indicating the supply source of the sheet that is used in printing. In a case where a user specifies a specific sheet feed cassette as a sheet feed cassette, the sheet feed cassette information 413 indicates one of the cassettes 141 to 144 and the manual feed tray 145. It is possible to set specification of a sheet feed cassette as an optional item and in a case where a user does not specify any sheet feed cassette, information indicating “auto selection” is stored as the sheet feed cassette information 413. Further, as described above, in a case where the sheet feed cassettes from which a sheet is fed are switched for each set, as the sheet feed cassette information 413, information in which a sheet feed cassette is set for each set is stored. In a case where a plurality of sheet feed cassettes is set in the sheet feed cassette information 413, it is determined that the sheet feed cassettes are switched for each set.

The sheet size 414 is information indicating the sheet size specified by a user. As the sheet size, information common to one print job is set. The sheet direction 415 is information indicating the sheet direction specified by a user. In a case where a user does not specify the sheet direction, the sheet direction 415 is omitted. The sheet type 416 is information indicating the sheet type specified by a user. It is possible to set specification of the sheet type as an optional item and in a case where a user does not specify any sheet type, the sheet type 416 is omitted. In the page data 420, image data of each page is included.

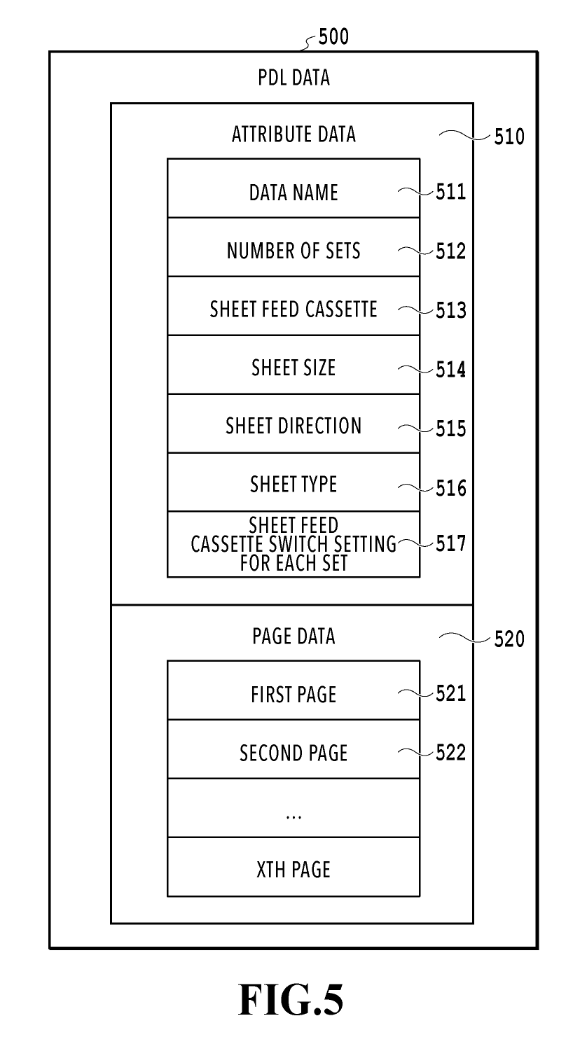

FIG. 5 is a conceptual diagram of PDL data in a case where the sheet feed cassettes are switched for each set. Of attribute data 510 of PDL data 500 shown in FIG. 5, data name 511, number of sets 512, sheet feed cassette information 513, sheet size 514, sheet direction 515, and sheet type 516 are the same as the contents explained by using FIG. 4. In the PDL data 500, sheet feed cassette switch setting for each set 517 is included. The sheet feed cassette switch setting for each set 517 is information for determining whether instructions to switch sheet feed cassettes for each set are given by the print driver 250. It may also be possible for the MFP 100 to determine whether to perform sheet feed cassette switch processing for each set by referring to the sheet feed cassette switch setting for each set 517. Page data 520 included in the PDL data 500 is the same as that explained by using FIG. 4.

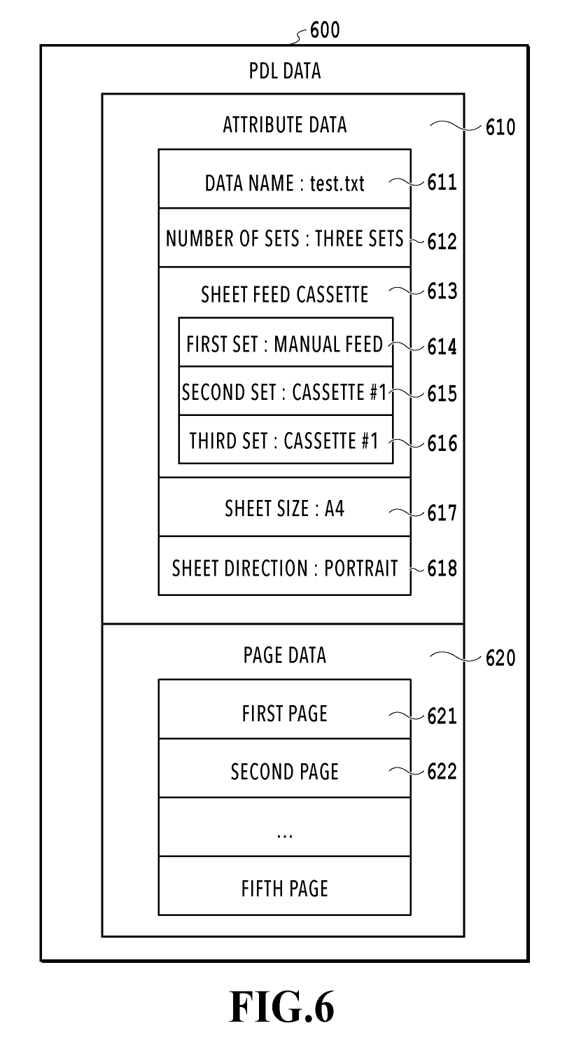

FIG. 6 is a diagram showing a specific example of PDL data. In FIG. 6, a specific example of PDL data in the format shown in FIG. 4 is shown. In the present embodiment, it is assumed that PDL data in the format shown in FIG. 4 is transmitted from the PC 160 to the MFP 100. In PDL data 600, as data name 611 of attribute data 610, test.txt is set and as number of sets 612, three sets are set. As sheet feed cassette information 613, to a first set 614, “manual feed” is set, to a second set 615, “cassette #1” is set, and to a third set 616, “cassette #1” is set, respectively. As described above, a plurality of pieces of information is included in the sheet feed cassette information 613 of the attribute data 610 of the PDL data 600, and therefore, in the MFP 100, processing to switch the sheet feed cassettes for each set is performed. To sheet size 617, A4 is set, and to sheet direction 618, portrait is set, respectively. In the PDL data 600, sheet type is not set. In page data 620, data corresponding to five pages is included.

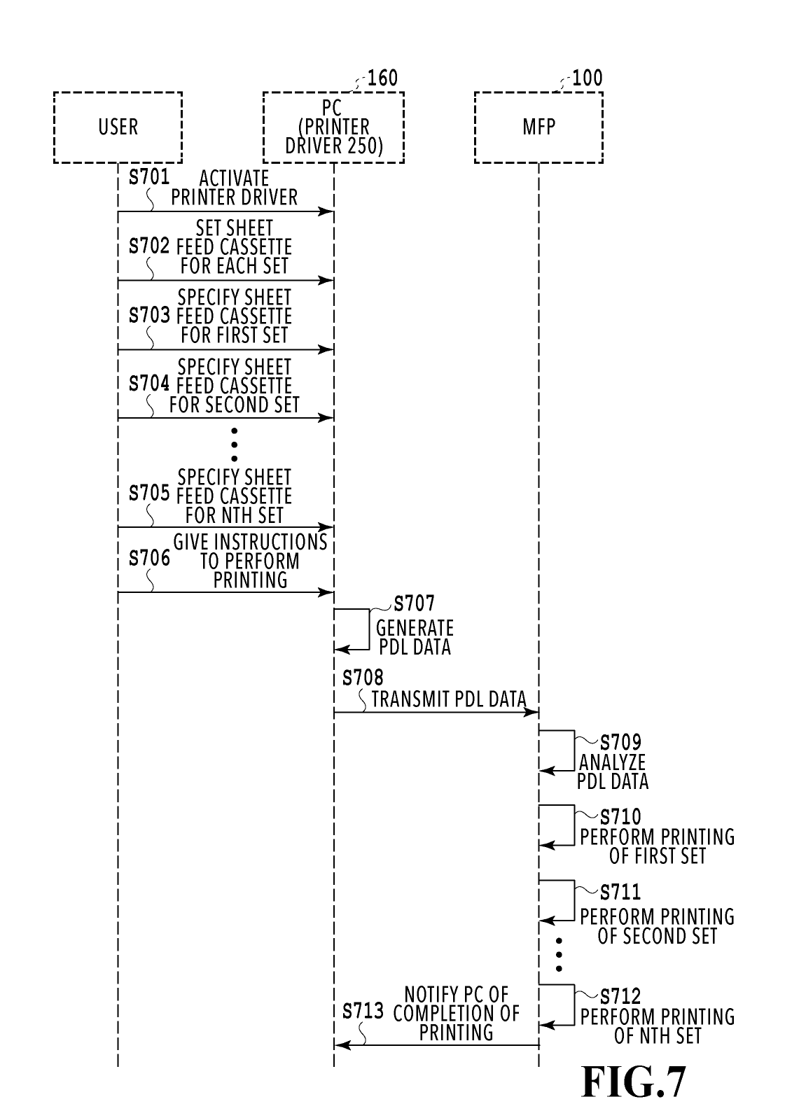

FIG. 7 is a sequence diagram showing processing from activation of the printer driver 250 by a user until printing in the MFP 100 is completed. A user activates the printer driver 250 by the PC 160 (step S701). Then, the user performs print setting via a print setting screen that is displayed by the UI unit 251 of the printer driver 250. Here, the user selects the sheet feed cassette setting for each set and sets the sheet feed cassette for each set on the UI screen shown in FIG. 3A (steps S702 to S705).

The user gives instructions to perform printing for the MFP 100 to the printer driver 250 (step S706). The printer driver 250 generates PDL data based on the set print setting (step S707). The printer driver 250 transmits the PDL data to the MFP 100 (step S708).

Upon receipt of the PDL data, the MFP 100 analyzes the received PDL data (step S709). The MFP 100 performs printing of the first set in accordance with the analyzed PDL data. At this time, the sheet is supplied from the sheet feed cassette specified to the first set in the PDL data (step S710). The MFP 100 performs printing a number of times corresponding to the number of printing sets set in the PDL data (steps S711, S712). In a case where printing is completed for all the number of sets, the MFP 100 notifies the PC 160 of the completion of the printing (step S713).

### <General Printing Processing>

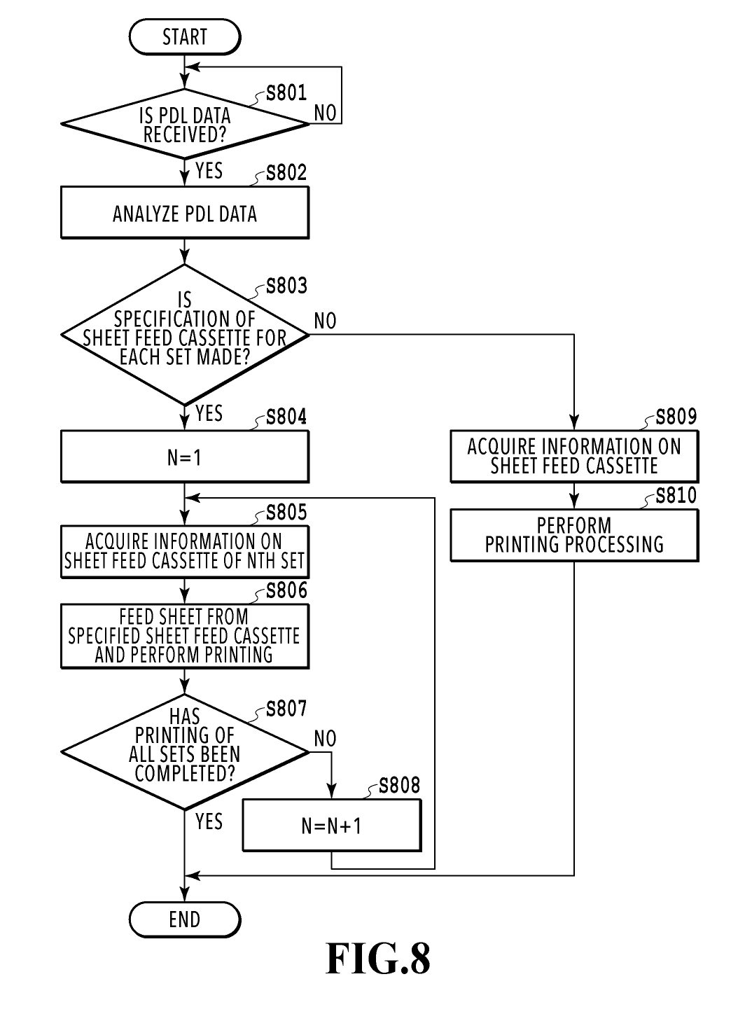

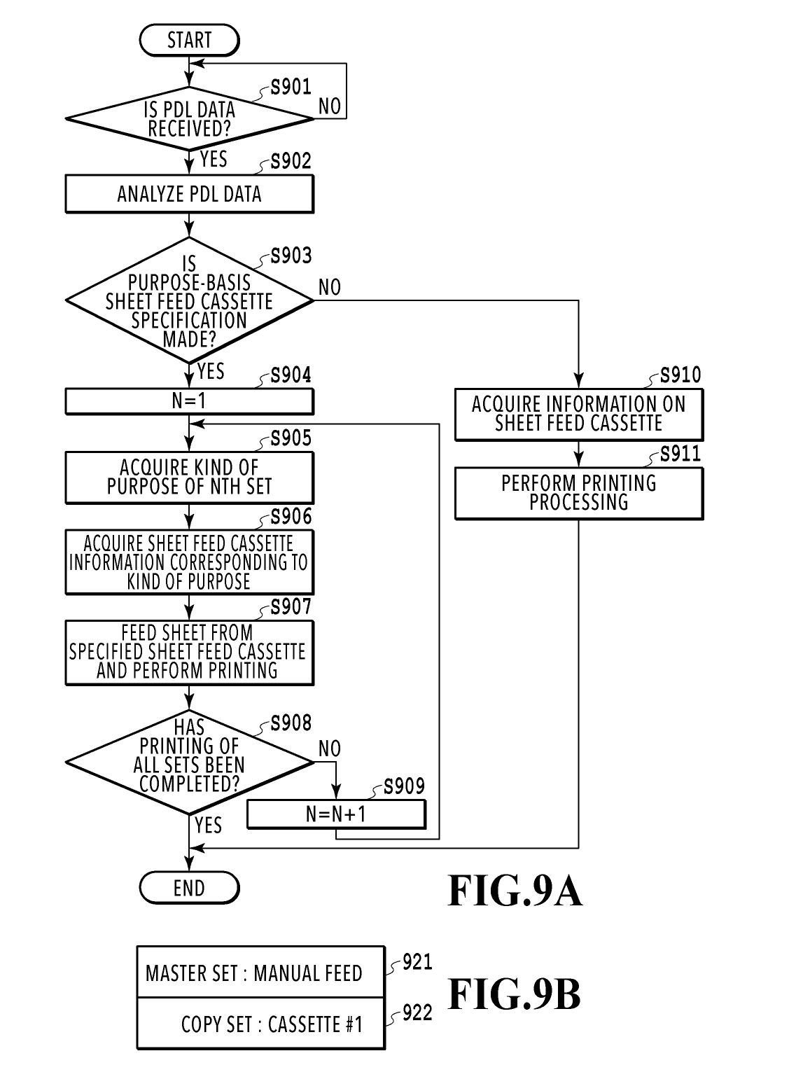

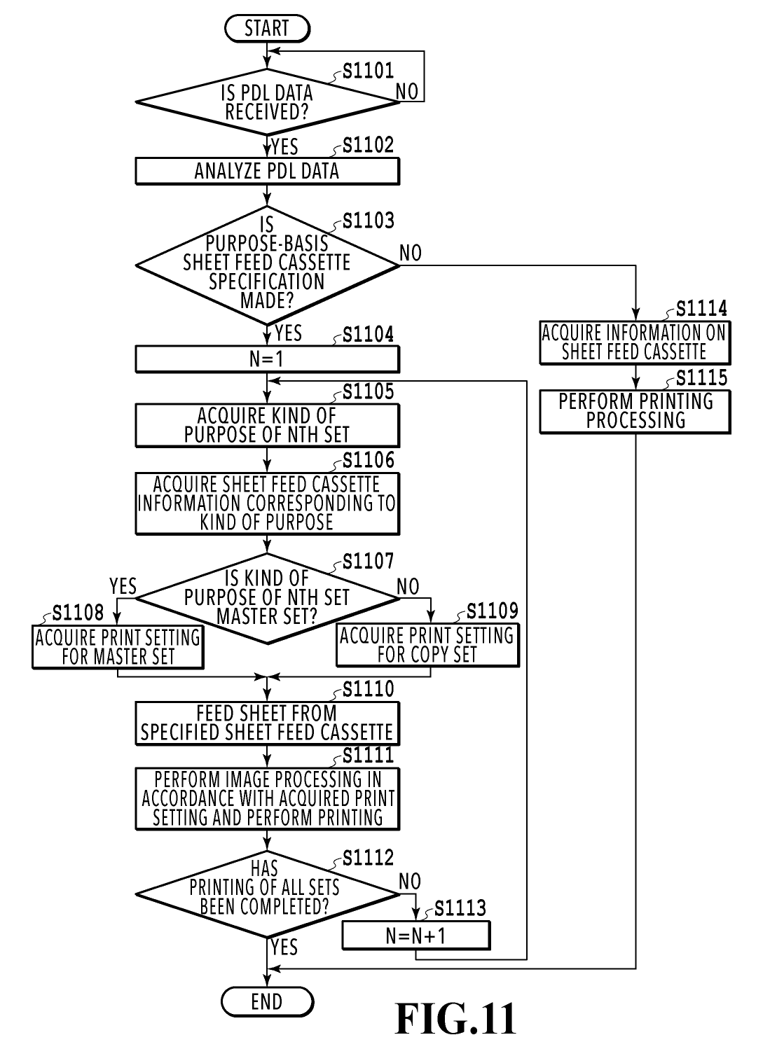

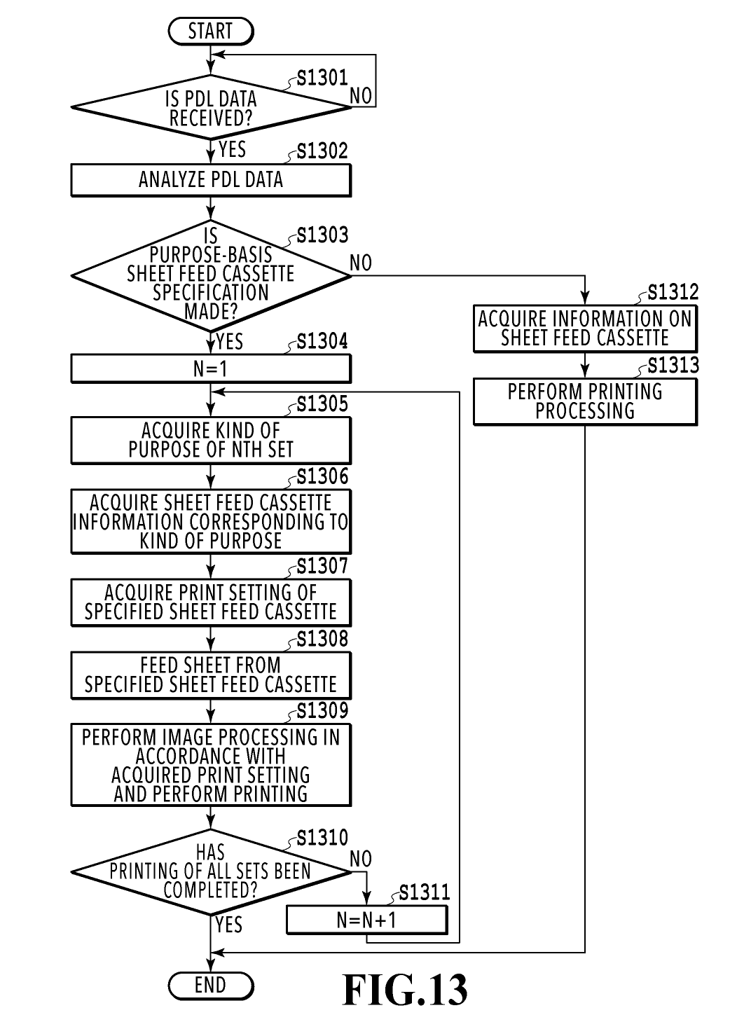

FIG. 8, FIG. 9A, and FIG. 9B are diagrams for explaining general printing processing performed at steps S709 to S712 shown in FIG. 7. In FIG. 8, a flowchart of printing processing performed by switching sheet feed cassettes for each set is shown. The processing shown in FIG. 8 is implemented by the control unit 110 causing the CPU 111 to execute a program stored in the ROM 113. Processing shown in FIG. 9A, FIG. 11, and FIG. 13, to be described later, is also implemented similarly.

At step S801, the control unit 110 determines whether or not PDL data is received. In a case where PDL data is received (YES at step S801), the MFP 100 advances to the processing at step S802. At step S802, the control unit 110 analyzes the received PDL data. Then, the control unit 110 acquires at least each piece of information, that is, sheet feed cassette information, sheet size, sheet direction, and sheet type from the attribute data of the PDL data.

At step S803, the control unit 110 determines whether there is a change setting of the sheet feed cassette for each set. In a case where there is a change setting (YES at step S803), the control unit 110 advances to the processing at step S804. In a case where there is not a change setting (NO at step S803), the control unit 110 advances to the processing at step S809.

It is possible to perform the determination processing at step S803 by determining whether setting information on a plurality of sheet feed cassettes is stored in the sheet feed cassette information included in the attribute data of the received PDL data. That is, in a case where setting information on a plurality of sheet feed cassettes is stored in the sheet feed cassette information, the control unit 110 determines that there is a change setting of the sheet feed cassette for each set. On the other hand, in a case where setting information on a plurality of sheet feed cassettes is not stored in the sheet feed cassette information, the control unit determines that there is not a change setting of the sheet feed cassette for each set. In a case where the sheet feed cassette switch setting for each set is included in the attribute data as attribute, as in the PDL 500, it may also be possible to perform the determination in accordance with the value set to the attribute.

At step S804, the control unit 110 initializes a counter N of the number of sets to 1. At step S805, the control unit 110 acquires information on the sheet feed cassette of the Nth set from the sheet feed cassette information. At step S806, the control unit 110 performs sheet feed from the sheet feed cassette specified to the Nth set and performs printing processing using page data (image data) included in the PDL data. At this time, the control unit 110 performs image rotation processing in accordance with the sheet direction, switching of fixing conditions in accordance with the sheet type, and so on, and prints an image on the sheet. At step S807, the control unit 110 compares the number of sets set in the PDL data and the counter N and determines whether printing of all the number of sets is completed. In a case where printing of all the number of sets is completed (YES at step S807), the control unit 110 terminates the processing. On the other hand, in a case where printing of all the number of sets is not completed (NO at step S807), the control unit 110 advances to the processing at step S808. At step S808, the control unit 110 adds 1 to the counter N and returns to the processing at step S805.

At step S809, the control unit 110 acquires the sheet feed cassette information from the attribute data included in the PDL data. At step S810, the control unit 110 performs sheet feed from the sheet feed cassette set in the sheet feed cassette information and performs printing processing using page data (image data) included in the PDL data.

FIG. 9A shows a flowchart of printing processing that is performed by distinguishing between kinds of purpose (master set and copy set) and switching the sheet feed cassettes for each kind of purpose. The processing at steps S901, S902, and S908 to S911 is the same as the processing at steps S801, S802, and S807 to S810 in FIG. 8, and therefore, explanation is omitted.

At step S903, the control unit 110 determines whether specification of a sheet feed cassette is made for each kind of purpose (hereinafter, called purpose-basis sheet feed cassette specification). In a case where purpose-basis sheet feed cassette specification is made (YES at step S903), the control unit 110 advances to the processing at step S904. In a case where purpose-basis sheet feed cassette specification is not made (NO at step S903), the control unit 110 advances to the processing at step S910.

In a case where the sheet feed cassettes are switched for each kind of purpose, it is only required to store information specifying a sheet feed cassette for each kind of purpose (hereinafter, called purpose-basis sheet feed cassette information) in the sheet feed cassette information in the PDL data in the format shown in FIG. 4. Then, it is only required to perform the determination at step S903 based on whether or not the purpose-basis sheet feed cassette information is stored in the sheet feed cassette information. FIG. 9B shows an example of the purpose-basis sheet feed cassette information. In the example shown in FIG. 9B, as the purpose-basis sheet feed cassette information, “manual feed” is set to a master set 921 and “cassette #1” is set to a copy set 922, respectively. It may also be possible to add a setting to switch sheet feed cassettes for each kind of purpose (sheet feed cassette switch setting for each kind of purpose) to the attribute data of the PDL data by using the PDL data in the format shown in FIG. 5 and to perform the determination at step S903 based on the setting.

At step S904, the control unit 110 initializes the counter N of the number of sets to 1. At step S905, the control unit 110 acquires the kind of purpose (master set, copy set) of the Nth set. In the present embodiment, it is assumed that the control unit 110 determines that the kind of purpose of the first set is a master set and the kind of purpose of the second and subsequent sets are a copy set. It may also be possible to add kind of purpose information for each set indicating what number of set is taken to be the master set and what number of set is taken to be the copy set to the attribute data of the PDL data. Then, it may also be possible for the control unit 110 to acquire the kind of purpose of the Nth set from the kind of purpose information for each set. In order to implement such an aspect, for example, it is only required for the control unit 110 to display items for causing a user to set the kind of purpose information for each set on the UI screen shown in FIG. 3B and to cause the user to perform setting via the UI screen.

At step S906, the control unit 110 acquires the sheet feed cassette information corresponding to the kind of purpose of the Nth set from the purpose-basis sheet feed cassette information stored in the sheet feed cassette information. At step S907, the control unit 110 performs sheet feed from the sheet feed cassette indicated by the acquired sheet feed cassette information and performs printing processing using page data (image data) included in the PDL data for the fed sheet.

As described above, it is made possible to perform printing processing by making the setting of the sheet feed cassette differ for each set. However, in the printing processing shown in FIG. 8 and FIG. 9A, the settings other than the sheet feed cassette are made common to each set. Consequently, there is a possibility that stamp printing or combination printing of a copy-forgery-inhibited pattern or the like desired to be performed for the copy set is also performed for the master set and printed matter (product) not desired by a user is generated. Further, in order to prevent such printed matter from being generated, it is necessary to perform print setting for the printer driver for the master set and the copy set individually.

Consequently, in the present embodiment, as described below, the print setting at least for the copy set is stored in advance in the storage device and the MFP 100 performs printing processing for the copy set by using the print setting read from the storage device. By doing so, in the present embodiment, it is made possible for a user to generate printed matter intended by the user without the user performing print setting for the master set and the copy set individually. In the following, printing processing in the present embodiment is explained.

### <Printing Processing in the First Embodiment>

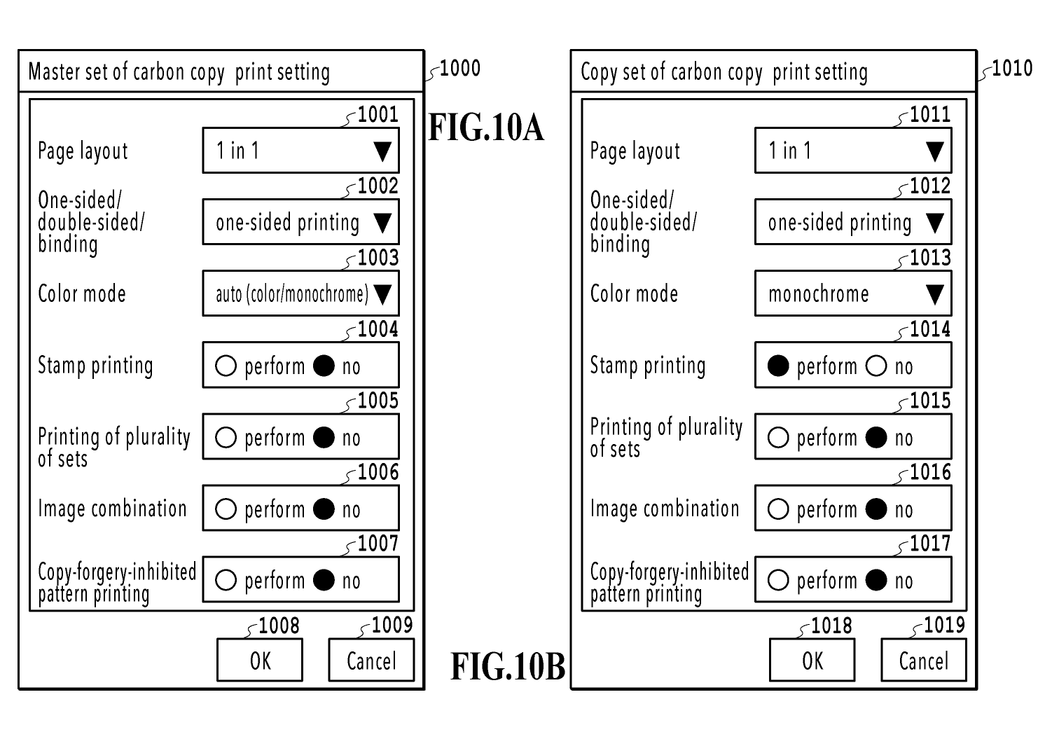

FIG. 10A and FIG. 10B are diagrams each showing an example of a UI screen of the MFP 100 for performing print setting for the MFP 100 for each kind of purpose (master set, copy set). A print setting screen 1000 shown in FIG. 10A is an example of a screen for performing print setting for a master set of carbon copy. A print setting screen 1010 shown in FIG. 10B is an example of a screen for performing print setting for a copy set of carbon copy. The UI screens shown in FIG. 10A and FIG. 10B are displayed on the operation unit 150 by the control unit 110 performing display control so as to output image data that is displayed on those UI screens to the operation unit 150.

On the print setting screens 1000 and 1010, dropdown lists and radio buttons for performing various kinds of print setting (page layout setting, finish setting, color mode setting, and combination print setting) are arranged. Dropdown lists 1001 and 1011 are for specifying a page layout, more specifically, for specifying the number of pages to be printed on a sheet, that is, for making specification of N in 1. Dropdown lists 1002 and 1012 are for setting a mode in which printing is finished of one-sided printing, double-sided printing, and binding printing. Dropdown lists 1003 and 1013 are for setting a color mode of printing. Radio buttons 1004 to 1007 and 1014 to 1017 are buttons for setting whether or not to perform combination printing. The radio buttons 1004 and 1014 are for setting whether or not to perform stamp printing and the radio buttons 1005 and 1015 are for setting whether or not to perform printing of a plurality of sets. The radio buttons 1006 and 1016 are for setting whether or not to perform image combination and the radio buttons 1007 and 1017 are for setting whether or not to perform copy-forgery-inhibited pattern printing. Further, on the print setting screens 1000 and 1010, OK buttons 1008 and 1018 for settling setting and Cancel buttons 1009 and 1019 for cancelling setting are arranged. In the example shown in FIG. 10A, print setting for performing printing by 1 in 1, one-sided printing, and color mode automatic printing for a master set is set. In the example shown in FIG. 10B, print setting for performing printing by 1 in 1, one-sided printing, and monochrome printing for a copy set is set. Further, in the example shown in FIG. 10B, print setting for performing stamp printing is set.

Information set for each kind of purpose (hereinafter, called purpose-basis print setting information) on the print setting screens 1000 and 1010 is registered in the MFP 100 by the control unit 110. Specifically, the purpose-basis print setting information is stored in the storage device (in the present embodiment, the storage unit 114 of the control unit 110) by the control unit 110.

In the present embodiment, it is only required for the information set on the print setting screen 1010 to be stored at least in the storage device. That is, it is only required for only the purpose-basis print setting information corresponding to a copy set to be stored in the storage device. In a case where it is desired to apply stamp printing and the like only to a master set, it may also be possible to store only the information set on the print setting screen 1000 in the storage device.

FIG. 11 is a flowchart showing an example of printing processing to distinguish between the kinds of purpose (master set and copy set) and to switch print settings for each kind of purpose. The processing at steps S1101 to S1106 shown in FIG. 11 is the same as the processing at steps S901 to S906, and therefore, explanation is omitted.

At step S1107, the control unit 110 determines whether or not the Nth set is a master set from the kind of purpose of the Nth set, which is acquired at step S1105. In a case where the Nth set is a master set (YES at step S1107), at step S1108, the control unit 110 acquires the print setting set via the print setting screen 1000. More specifically, the control unit 110 reads the purpose-basis print setting information corresponding to the master set from the storage unit 114. On the other hand, in a case where the Nth set is not a master set, that is, a copy set (NO at step S1107), at step S1109, the control unit 110 acquires the print setting set via the print setting screen 1010. More specifically, the control unit 110 reads the purpose-basis print setting information corresponding to the copy set from the storage unit 114.

At step S1110, the control unit 110 performs sheet feed from the sheet feed cassette specified to the Nth set, which is indicated by the sheet feed cassette information acquired at step S1106. Then, at step S1111, the control unit 110 performs printing processing using page data (image data) included in the PDL data for the fed sheet. At this time, the control unit 110 performs image processing in accordance with the print setting acquired at step S1108 or step S1109. Further, at this time, the control unit 110 gives priority to the print setting acquired at step S1108 or step S1109 and applies the print setting to the image processing even though combination print setting or the like is included in the PDL data received at step S1101. Due to this, it is made possible to print a stamp or a copy-forgery-inhibited pattern only for the copy set. The processing at steps S1112 to S1115 is the same as the processing at steps S908 to S911 shown in FIG. 9A, and therefore, explanation is omitted.

As explained above, in the present embodiment, at the time of performing printing of a plurality of sets, the MFP 100 determines the kind of purpose for each set and reads the print setting corresponding to the kind of purpose of each set from the storage device. Then, the MFP 100 applies image processing in accordance with the read print setting to the image data to be printed for each set. Consequently, according to the present embodiment, for example, in a case where printing is performed by distinguishing between a master set and a copy set by making use of the carbon copy function, it is no longer necessary for a user to individually perform the setting whether or not to perform combination printing for each set. Further, according to the present embodiment, it is made possible to apply a specific print setting (for example, setting indicating whether or not to perform combination printing) to a specific kind of set (for example, copy set). Due to this, it no longer occurs that a specific print setting is applied to a kind of set (for example, master set) different from the specific kind of set. That is, at the time of performing printing of a plurality of sets including a master set and a copy set, it is possible to perform combination printing and the like only for the copy set and it is possible to prevent combination printing and the like from being performed for the master set.

As described above, according to the present embodiment, it is made possible to generate printed matter (product) intended by a user without performing print setting individually for each set. Further, it is not necessary to individually perform print setting for each set, and therefore, it is made possible to make easier the user operation at the time of making use of the carbon copy function. In the first embodiment, the carbon copy function is a function that cause a printing apparatus output a plurality of print products including a master set (a main copy) and a copy set (a sub copy) based on the same print data. A type of sheet used in an execution of the sub copy print function is not limited to a carbon paper, and any type of paper can be used. The explanation for the sub copy print function described above applies to other exemplary embodiments described below.

In the present embodiment, the case where the information (purpose-basis print setting information) set for each kind of purpose on the print setting screens 1000 and 1010 is stored in the storage device of the MFP 100 (the storage unit 114 of the control unit 110) is taken as an example. However, it may also be possible to store in advance the purpose-basis print setting information in an external storage device of the MFP 100 and for the MFP 100 to acquire the purpose-basis print setting information from the storage device.

Further, in the present embodiment, the example in which registration of print setting is performed for the MFP 100 via the UI screen of the MFP 100 is explained. However, it may also be possible to display the print setting screen shown in FIG. 10A and FIG. 10B on the display unit of an external device (for example, an information processing apparatus, such as a PC and a mobile terminal) capable of communicating with the MFP 100 and to perform registration of print setting for the MFP 100 from the device. In order to implement such an aspect, for example, it is only required to store a program for displaying the print setting screen shown in FIG. 10A and FIG. 10B on the display unit and to cause the CPU of the device to execute the program.

Further, in the present embodiment, the case where the kinds of purpose are a master set and a copy set is explained, but the kinds of purpose are not limited to those. Furthermore, the number of kinds of purpose is not limited to two. For example, the number of kinds of purpose may be three or more. In order to implement such an aspect, it is only required to make it possible to display a print setting screen corresponding to each kind of purpose on the UI screen of the MFP 100 and to cause a user to perform print setting corresponding to each kind of purpose via the print setting screen.

### Second Embodiment

In a second embodiment, a method of performing printing in accordance with print setting corresponding to a sheet feed cassette, in place of the print setting corresponding to the kind of purpose, is explained. In the present embodiment, as in the first embodiment, it is assumed that PDL data in the format shown in FIG. 4 is transmitted from the PC 160 to the MFP 100 and that the above-described purpose-basis sheet feed cassette information is stored in the sheet feed cassette information of the PDL data. Further, in the present embodiment, as in the first embodiment, it is assumed that the kind of purpose of the first set is determined as a master set and the kind of purpose of the second and subsequent sets are determined as a copy set. As described above, it may also be possible to add kind of purpose information for each set to attribute data.

### <Printing Processing in the Second Embodiment>

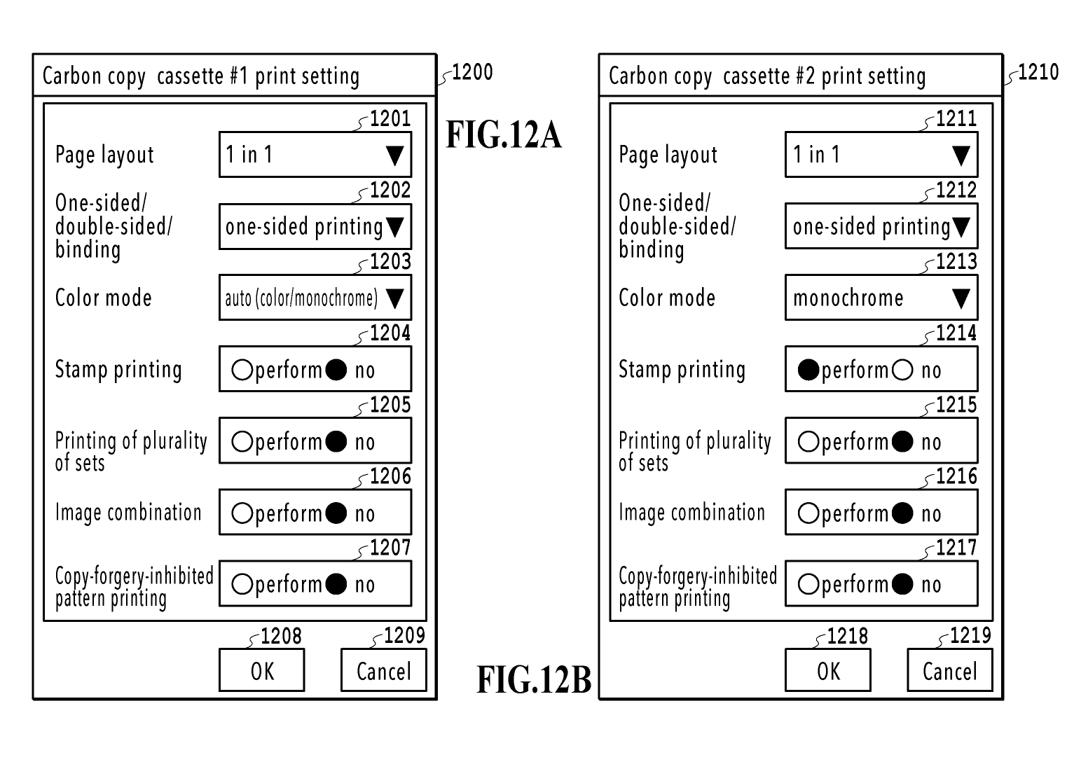

FIG. 12A and FIG. 12B are diagrams each showing an example of a UI screen for performing print setting for each sheet feed cassette. A print setting screen 1200 shown in FIG. 12A is an example of a screen for performing print setting for a source of supply (here, cassette #1 (cassette 141)) of a sheet that is used in printing of a master set of carbon copy. A print setting screen 1210 shown in FIG. 12B is an example of a screen for performing print setting for a source of supply (here, cassette #2 (cassette 142)) of a sheet that is used in printing of a copy set. The buttons and the like arranged on the print setting screens 1200 and 1210 are the same as those of the print setting screens 1000 and 1010 shown in FIG. 10A and FIG. 10B. In the example shown in FIG. 12A, for the sheet supplied from the cassette #1, print setting for performing printing by 1 in 1, one-sided printing, and color mode automatic printing is set. In the example shown in FIG. 12B, for the sheet supplied from the cassette #2, print setting for performing printing by 1 in 1, one-sided printing, and monochrome printing is set. Further, in the example shown in FIG. 10B, print setting for performing stamp printing is set.

Information set for each sheet feed cassette on the print setting screens 1200 and 1210 (sheet feed cassette-basis print setting information) is stored in the storage device (in the present embodiment, the storage unit 114 of the control unit 110) by the control unit 110. It may also be possible to store the sheet feed cassette-basis print setting information in an external storage device as in the case with the purpose-basis print setting information in the first embodiment.

FIG. 13 is a flowchart showing an example of printing processing to distinguish between kinds of purpose (master set and copy set) and to switch print settings for each kind of purpose. The processing at steps S1301 to 1306 shown in FIG. 13 is the same as the processing at steps S1101 to S1106 shown in FIG. 11, and therefore, explanation is omitted.

At step S1307, the control unit 110 acquires the print setting corresponding to the sheet feed cassette indicated by the sheet feed cassette information acquired at step S1306. More specifically, the control unit 110 reads the print setting information corresponding to the sheet feed cassette indicated by the sheet feed cassette information from the storage unit 114. For example, in a case where the sheet feed cassette indicated by the sheet feed cassette information is the cassette #1, the print setting shown in FIG. 12A, that is, the print setting in which 1 in 1, one-sided printing, and color mode automatic printing are specified is acquired. Further, for example, in a case where the sheet feed cassette indicated by the sheet feed cassette information is the cassette #2, the print setting shown in FIG. 12B, that is, the print setting in which 1 in 1, one-sided printing, and monochrome printing are specified is acquired.

At step S1308, the control unit 110 performs sheet feed from the sheet feed cassette indicated by the sheet feed cassette information. Then, at step S1309, the control unit 110 performs printing processing using page data (image data) included in the PDL data for the fed sheet. At this time, the control unit 110 performs image processing in accordance with the print setting acquired at step S1307. Due to this, it is made possible to apply the print setting different between the master set and the copy set. Consequently, as in the first embodiment, it is made possible to print a stamp or a copy-forgery-inhibited pattern only for the copy set. The processing at steps S1310 to S1313 is the same as the processing at steps S1112 to S1115 shown in FIG. 11, and therefore, explanation is omitted.

As explained above, in the present embodiment, the source of supply (sheet feed cassette) of the sheet corresponding to each set is determined and the print setting corresponding to the source of supply is read from the storage device. Then, image processing in accordance with the read print setting is applied to image data to be printed for each set. Due to this, it is possible to change the print setting in accordance with the kinds of sheet, that is, the sheet (for example, high-quality sheet) used for the master set and the sheet (for example, backing sheet) used for the copy set. For example, by storing the print setting information set so that combination printing is performed only for the sheet (sheet of the source of supply) used for the copy set as shown in FIG. 12A and FIG. 12B in the storage device, it is made possible to avoid a stamp or the like from being printed on the master set. That is, also in the printing processing in the present embodiment, as in the first embodiment, it is made possible for a user to generate printed matter intended by the user without individually performing print setting for each set.

In the present embodiment, it is only required for the information set on the print setting screen 1210 to be stored at least in the storage device. That is, it is only required only for the sheet feed cassette-basis print setting information corresponding to the source of supply (sheet feed cassette) of the sheet used in printing of the copy set to be stored in the storage device. In a case where it is desired to apply a specific print setting only for the source of supply (sheet feed cassette) of the sheet used in printing of the master set, it may also be possible to store only the information set on the print setting screen 1200 in the storage device.

Further, it may also be possible to display the print setting screen shown in FIG. 12A and FIG. 12B on the display unit of an external device (for example, an information processing apparatus, such as a PC and a mobile terminal) capable of communicating with the MFP 100 and to perform registration of the print setting for the MFP 100 from the device. In order to implement such an aspect, for example, it is only required to store a program for displaying the print setting screen shown in FIG. 12A and FIG. 12B on the display unit and to cause the CPU of the device to execute the program.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, it is made possible to generate printed matter intended by a user without the need for the user to perform print setting individually for a master set and a copy set.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-219381, filed Nov. 14, 2017, which is hereby incorporated by reference wherein in its entirety.

What is claimed is:

1. An image forming apparatus comprising:
a memory device that stores a set of instructions; and
at least one processor that executes the set of instructions to:
acquire a print setting registered in advance, which is applied to printing of a specific kind of set, or a print setting registered in advance, which is applied to printing on a sheet of a specific sheet feed cassette; and
apply the acquired print setting registered in advance in a case of performing printing of a plurality of sets including a set that is printed by using a sheet of a first sheet feed cassette and a set that is printed by using a sheet of a second sheet feed cassette based on specific print data for printing the plurality of sets.

2. The image forming apparatus according to claim 1, wherein
the at least one processor executes instructions in the memory device to:
further acquire a print setting registered in advance, which is applied to printing of a kind of set different from the specific kind of set; and
apply the acquired print settings in a case of performing printing of the plurality of sets based on the specific print data.

3. The image forming apparatus according to claim 1, wherein
in the plurality of sets, a master set and a copy set are included,
the specific kind of set is the copy set, and
the at least one processor executes instructions in the memory device to:
determine a first set of the plurality of sets as the master set and second and subsequent sets as the copy set.

4. The image forming apparatus according to claim 1, wherein
the at least one processor executes instructions in the memory device to:
display a user interface for at least specifying the print setting applied to printing of the specific kind of set or the print setting applied to printing on a sheet of the specific sheet feed cassette on a display unit; and
register the print setting specified via the user interface to the image forming apparatus.

5. The image forming apparatus according to claim 1, wherein
in the print setting, at least one of a setting indicating whether or not to perform combination printing, a page layout printing, a finish setting, and a color mode setting is included.

6. The image forming apparatus according to claim 1, wherein
in printing of the plurality of sets, one of stamp printing, printing of a plurality of sets, image combination, and copy-forgery-inhibited pattern printing is included.

7. An information processing apparatus comprising:
a memory device that stores a set of instructions; and
at least one processor that executes the set of instructions to:
perform control so as to cause a display unit to display a user interface for registering a print setting applied to a specific kind of set of a plurality of sets or a print setting applied to a specific sheet feed cassette to an image forming apparatus as a print setting for causing the image forming apparatus to print print data of the plurality of sets including a set that is printed by using a sheet of a first sheet feed cassette and a set that is printed by using a sheet of a second sheet feed cassette.

8. A control method of an image forming apparatus, the method comprising:
acquiring a print setting registered in advance, which is applied to printing of a specific kind of set, or a print setting registered in advance, which is applied to printing on a sheet of a specific sheet feed cassette; and
applying the acquired print setting registered in advance in a case of performing printing of a plurality of sets including a set that is printed by using a sheet of a first sheet feed cassette and a set that is printed by using a sheet of a second sheet feed cassette based on specific print data for printing the plurality of sets.

9. A control method of an information processing apparatus, the method comprising:
displaying, on a display unit, a user interface for at least registering a print setting applied to printing of a specific kind of set of a plurality of sets or a print setting applied to printing using a sheet of a specific sheet feed cassette to an image forming apparatus as a print setting for causing the image forming apparatus to print print data of the plurality of sets including a set that is printed by using a sheet of a first sheet feed cassette and a set that is printed by using a sheet of a second sheet feed cassette.

10. A non-transitory computer readable storage medium storing a set of instructions for causing a computer to perform a control method of an image forming apparatus, the method comprising:
acquiring a print setting registered in advance, which is applied to printing of a specific kind of set, or a print setting registered in advance, which is applied to printing on a sheet of a specific sheet feed cassette; and
applying the acquired print setting registered in advance in a case of performing printing of a plurality of sets including a set that is printed by using a sheet of a first sheet feed cassette and a set that is printed by using a sheet of a second sheet feed cassette based on specific print data for printing the plurality of sets.

11. A non-transitory computer readable storage medium storing a set of instructions for causing a computer to perform a control method of an information processing apparatus, the method comprising:
displaying, on a display unit, a user interface for at least registering a print setting applied to printing of a specific kind of set of a plurality of sets or a print setting applied to printing using a sheet of a specific sheet feed cassette to an image forming apparatus as a print setting for causing the image forming apparatus to print print data of the plurality of sets including a set that is printed by using a sheet of a first sheet feed cassette and a set that is printed by using a sheet of a second sheet feed cassette.
